(19) United States
(12) Patent Application Publication
(10) Pub. No.: US 2019/0347630 A1
(43) Pub. Date: Nov. 14, 2019

(54) SYSTEM AND METHOD FOR CONDUCTING ELECTRONIC TRANSACTIONS THROUGH PERSONAL ELECTRONIC TRANSACTION CARD

(71) Applicant: Shikhar Gahlaut, Haridwar, Uttarakand (IN)

(72) Inventor: Shikhar Gahlaut, Haridwar, Uttarakand (IN)

(21) Appl. No.: 16/476,086

(22) PCT Filed: Mar. 15, 2017
(86) PCT No.: PCT/IB17/51489

§ 371 Date: Jul. 4, 2019

(30) Foreign Application Priority Data
Jan. 5, 2017 (IN) 201711000512

(51) Int. Cl. G06Q 20/10; G06Q 20/26

(52) U.S. Cl. CPC G06Q 20/108; G06Q 20/26

(57) ABSTRACT

The present disclosure relates to system and method for executing financial transactions for all bank accounts through a single personal electronic card (PEC). In an aspect, the system receives the user's bank account information that is specific to a bank; transmits, through a PEC platform, the user's bank account information to the bank; receives a cipher code from the bank based on processing of the user's bank account information at the bank such that the cipher code is unique to the user's bank account information; enables the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

### FIELD OF THE INVENTION

The present disclosure relates to personal electronic card (PEC). In particular, the present disclosure pertains to a system and method for executing financial transactions for all bank accounts through a single PEC.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Traditionally, when a user/customer purchases items/goods or avails services from third-parties(also referred to as merchants) such as a restaurant, a food court, a hospital, an online marketplace the customer pays a cost in exchange of the purchase. There are various mechanisms through which payment can be executed, one being a cash transaction while other mechanisms include mobile banking enabled payment, wallet-based payment, card-based payment (for example through debit or cash or credit card). These cards can be made of plastic based material having a magnetic strip that can work in a plurality of merchant's point of sale (POS), automated teller machines (ATMs), and other electronic devices that enables card based financial transactions.

FIG. 1 illustrates an existing small plastic based debit card issued by a bank, allowing the user to withdraw cash from ATM kiosk, purchase goods or services by making appropriate payment. Such card can include plurality of other information such as user name, image, card number, type of card (visa/master/amex) etc.

As different banks offer various offers/discounts/redemption policies, user carries multiple credit/debit cards (of different banks) to avail best services out of them. Individual bank further provide different membership levels (silver, gold, platinum) for card/user.

Carrying/using multiple cards leads to multiple problems such as hassle of maintaining multiple cards and respective account numbers, increase risk of insecurity/hacking/fraudulent activities, more susceptible faults, etc. Furthermore, existing cards do not have adequate processing power, display unit for performing online transaction from it.

There is therefore a need for a method and system that provides a universal card for all the bank accounts and eliminates the need for carrying multiple transaction cards. Such card can include a display unit that can be utilized by the user to perform online financial transactions (fund transfer, online shopping).

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

An object of the present disclosure is to overcome one or more disadvantages associated with conventional financial systems.

An object of the present disclosure is to use a single card for all the transactions of different banks.

An object of the present disclosure is to make more secure payments by enabling cipher text and biometrics.

An object of the present disclosure is to utilize a single card for any financial service in which payment is required.

An object of the present disclosure is to provide a thin card that can be carried in a user wallet.

An object of the present disclosure is to enable banks, users, merchants, Government authorities etc. to collaborate through common PEC platform and enable execution of financial transactions.

### SUMMARY

The present disclosure relates to personal electronic card (PEC). In particular, the present disclosure pertains to a system and method for executing financial transactions for all bank accounts through a single PEC.

In an aspect, the present disclosures relates to a personal electronic card (PEC) for execution of financial transactions by a user of the PEC comprising a transceiver means, a display means, a non-transitory storage device having embodied therein one or more routines operable to facilitate execution of one or more financial transactions by the user; and one or more processors coupled to the non-transitory storage device and operable to execute the one or more routines, wherein the one or more routines include: a bank account information receive module, which when executed by the one or more processors, receives the user's bank account information that is specific to a bank; a bank account information transmission module, which when executed by the one or more processors, transmits, through a PEC platform, the user's bank account information to the bank; a cipher code receive module, which when executed by the one or more processors, receives a cipher code from the bank based on processing of the user's bank account information at the bank such that the cipher code is unique to the user's bank account information; a financial transaction execution module, which when executed by the one or more processors, enables the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

In an aspect, the common PEC platform can be configured at a server or at a cloud.

In an aspect, the user can be enabled to add one or more bank accounts to the PEC, wherein each bank account has a corresponding cipher code that is associated with the PEC.

In an aspect the cipher code can be associated with a bank icon that is displayed on a display screen of the PEC, and wherein selection of the bank icon is used to initiate at least one financial transaction with a third-party through the bank.

In an aspect one or more financial transactions can be executed using biometric authentication of the user on the PEC.

In an aspect, the user's bank account information comprises any or a combination of user's bank account number, user's name, bank branch name, bank name, and bank IFSC code.

In an aspect, the present disclosures relates to a method for execution of financial transactions by a user of a PEC by receiving user's bank account information that is specific to a bank; transmitting the user's bank account information, through a PEC platform, to the bank; receiving a cipher code from the bank based on processing of the user's bank account information at the bank such that the cipher code is unique to the user's bank account information; enabling the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The diagrams are for illustration only, which thus is not a limitation of the present disclosure, and wherein:

FIG. 1 illustrates an existing debit card issued by a bank.

FIG. 2 illustrates exemplary personal electronic card (PEC) in accordance with an embodiment of the present disclosure.

FIG. 3 illustrates exemplary communication between PEC user and a bank through PEC platform in accordance with an embodiment of the present disclosure.

FIG. 4 illustrates an exemplary registration form to receive bank information from user in accordance with embodiments of the present disclosure.

FIG. 5 illustrates an exemplary PEC platform database for maintaining/storing user and bank communication information in accordance with embodiments of the present disclosure.

FIG. 6 illustrates exemplary functional modules that can be implemented at PEC and bank respectively in accordance with an embodiment of the present disclosure.

FIG. 7 illustrates an exemplary PEC interface including multiple banks for executing financial transactions in accordance with embodiments of the present disclosure.

FIG. 8 illustrates an exemplary block diagram illustrating shopping from online marketplace by utilizing PEC in accordance with embodiments of the present disclosure.

FIG. 9 illustrates an exemplary block diagram illustrating shopping through POS by utilizing PEC in accordance with embodiments of the present disclosure.

FIG. 10 illustrates an exemplary flow diagram showing steps involved in setting up a PEC for execution of financial transactions by a user of a PEC in accordance with embodiments of the present disclosure.

FIG. 11 illustrates an exemplary flow diagram showing steps involved in issuance a cipher code for financial transaction execution, in accordance with embodiments of the present disclosure.

FIG. 12 illustrates an exemplary computer system in which or with which embodiments of the present invention may be utilized in accordance with embodiments of the present disclosure.

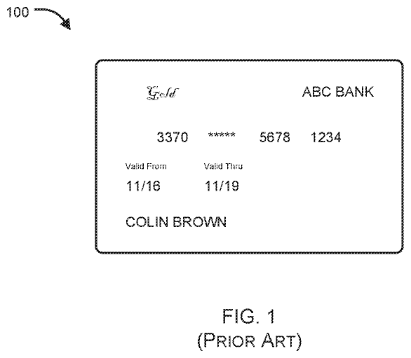

### DETAILED DESCRIPTION OF DRAWINGS

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

The present disclosure relates to personal electronic card (PEC). In particular, the present disclosure pertains to a system and method for executing financial transactions for all bank accounts through a single PEC.

In an aspect, the present disclosures relates to a personal electronic card (PEC) for execution of financial transactions by a user of the PEC comprising a transceiver means, a display means, a non-transitory storage device having embodied therein one or more routines operable to facilitate execution of one or more financial transactions by the user; and one or more processors coupled to the non-transitory storage device and operable to execute the one or more routines, wherein the one or more routines include: a bank account information receive module, which when executed by the one or more processors, receives the user's bank account information that is specific to a bank; a bank account information transmission module, which when executed by the one or more processors, transmits, through a PEC platform, the user's bank account information to the bank; a cipher code receive module, which when executed by the one or more processors, receives a cipher code from the bank based on processing of the user's bank account information at the bank such that the cipher code is unique to the user's bank account information; a financial transaction execution module, which when executed by the one or more processors, enables the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

In an aspect, the common PEC platform can be configured at a server or at a cloud.

In an aspect, the user can be enabled to add one or more bank accounts to the PEC, wherein each bank account has a corresponding cipher code that is associated with the PEC.

In an aspect the cipher code can be associated with a bank icon that is displayed on a display screen of the PEC, and wherein selection of the bank icon is used to initiate at least one financial transaction with a third-party through the bank.

In an aspect one or more financial transactions can be executed using biometric authentication of the user on the PEC.

In an aspect, the user's bank account information comprises any or a combination of user's bank account number, user's name, bank branch name, bank name, and bank IFSC code.

In an aspect, the present disclosures relates to a method for execution of financial transactions by a user of a PEC by receiving user's bank account information that is specific to a bank; transmitting the user's bank account information, through a PEC platform, to the bank; receiving a cipher code from the bank based on processing of the user's bank account information at the bank such that the cipher code is unique to the user's bank account information; enabling the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

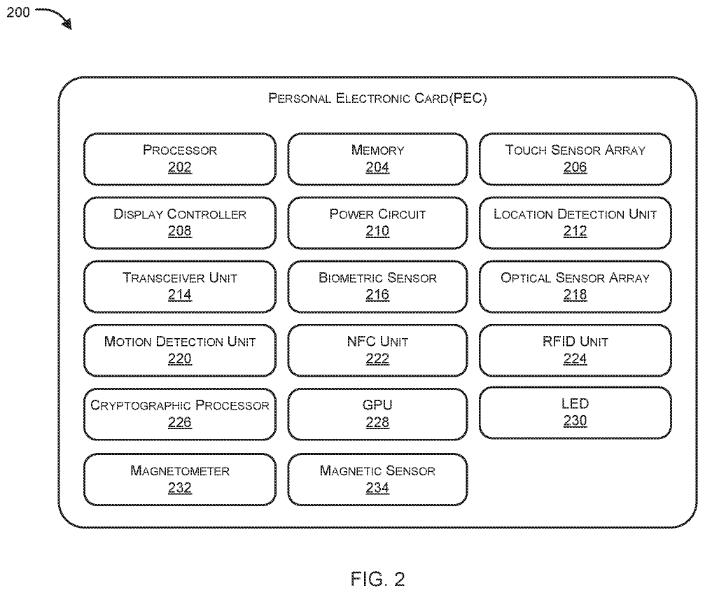

FIG. 2 illustrates exemplary personal electronic card (PEC) in accordance with an embodiment of the present disclosure. In an embodiment, proposed PEC 200 can be utilized as a single card for all the financial transactions through the banks in which user hold account. In an aspect, PEC can include a processor 202, a memory (RAM and ROM) 204, a touch sensor array 206 to enable touch screen interface, a display controller 208 to enable display screen, a power circuit 210, a location detection unit 212, a transceiver unit 214 to communicate with a bank server and/or other devices, a biometric sensor 216 and/or other sensors (proximity, accelerometer, magnetometer), an optical sensor array 218, a motion detection unit 220, a near field communication (NFC) means 222, a radio frequency identification (RFID) means 224, a cryptographic processor 226, a graphics processing unit (GPU) 228, a LED 230, a magnetometer 232, and a magnetic sensor 234 (that can be reset to work as a magnetic strip).

In an aspect, processor 202 can be operatively coupled with other PEC components such as memory 204, wherein memory can include an operating system (such as Android, Windows, iOS), PEC unique identifier, banking account details, previous transaction history, and combinations thereof. Processor 202 can also be operatively coupled with motion detection unit 220, an optical sensor array 218, and touch sensor array 206. A user input can be performed on the touch sensor array 206 that may include a touch screen panel, a keypad, or a combination thereof. The display controller 208 enables display of media file (such as a bank logo, or other images), an alphanumeric sequence and any other information on the display screen. A power circuit/battery 210 can provide power to PEC components, in case, PEC is misplaced/lost, location detection unit 212 can be used to locate the PEC, and biometric sensor 216 can be used for user authentication.

In an aspect, magnetic data symbols can also be generated and aligned according to the rate at which a magnetic card reader can read the data from the PEC.

In an aspect, PEC can include a casing so as to fit into a pocket/purse. Such casing can be implemented with or without the screws and/or fasteners.

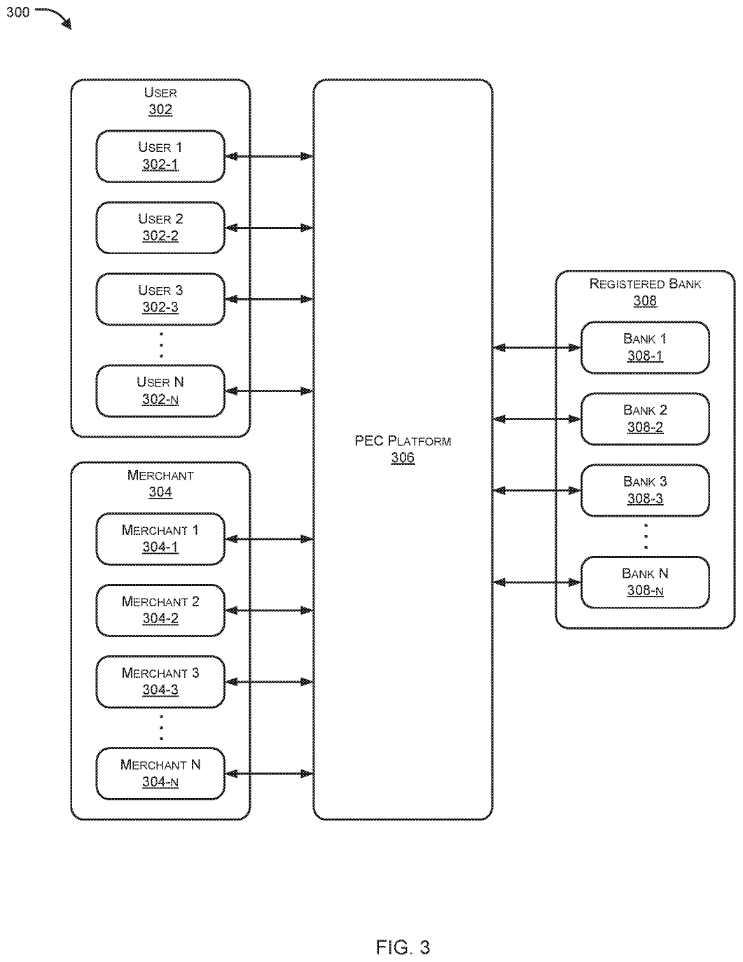

FIG. 3 illustrates exemplary communication between PEC user and a bank through common PEC platform in accordance with an embodiment of the present disclosure.

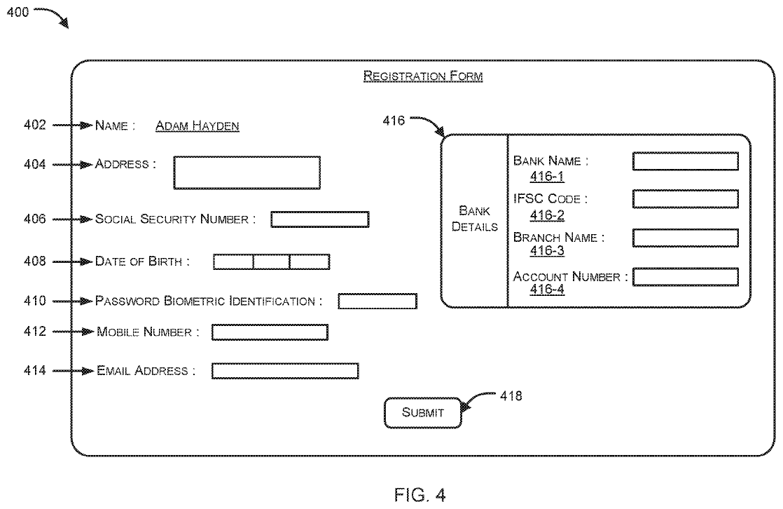

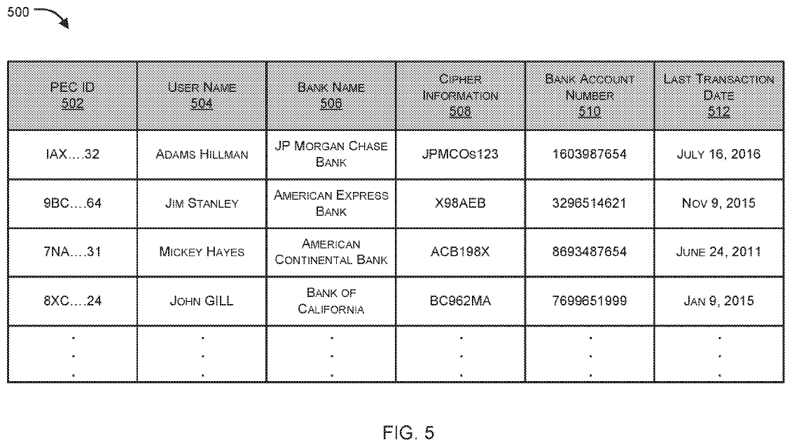

In an aspect, user 302-1, user 302-2, user 302-3 . . . user 302-n (collectively referred to as user 302 hereinafter) and/or merchant 304-1, merchant 304-2, merchant 304-3 . . . merchant 304-n (collectively referred to as merchant 304 hereinafter) can be registered (described in FIG. 4) with one or more of bank 308-1, bank 308-2 . . . bank 308-n (collectively referred to as bank 308 hereinafter) through a common PEC platform 306 (configured, for instance, at a server or cloud). PEC platform 306 can be utilized for enabling communication among the user 302, merchant 304 and bank 308, wherein such communication can be performed through an electronic communication network (such as Internet or Local Area Network (LAN) or Wide Area Network (WAN)). In an embodiment, PEC platform 306 can include a PEC database (described as FIG. 5) that maintains all relevant details pertaining to registered bank 308, registered user 302, financial transactions etc.

In an aspect, both user and bank server (interchangeably referred as bank) can be registered at the PEC platform 306 to avail services of the PEC. In an aspect, PEC platform can perform third party verification against the bank that wishes for registration and based on verification, the bank can be registered at the PEC platform. Once user and a bank get registered, both can interact with each other through common PEC platform 306 to execute financial transactions.

In an aspect, PEC can be utilized for making financial transactions to any service (that is registered on PEC platform 306) in which online payment can be performed, such services can be, including but not limited to, interbank transfers, income tax system, healthcare systems, flight/train tickets, online marketplace, stock market, commodity market, national trading, POS, and the like.

FIG. 4 illustrates an exemplary registration form to receive bank information from user in accordance with embodiments of the present disclosure. As shown in FIG. 4, bank information form 400 (interchangeably referred as registration form) can include name of user 402, address 404, unique identification number 406 such as social security number, date of birth 408, password/biometric identification number 410, mobile number (for receiving alerts/notifications) 412, email address 414, and bank details (for linking PEC with bank) 316 such as bank name 416-1, IFSC code 416-2, branch name 416-3, account number 416-4, and submit button 418. In an aspect, an identifier that uniquely identifies a PEC can also be transmitted to the bank. In an aspect, among all the entries, few entries annotated with asterisk may be made mandatory for submission by the user such as name of user 402, unique identification number 406 such as social security number, password/biometric identification number 310, and bank name 416-1, IFSC code 416-2, branch name 416-3, bank account number 416-4 etc. while other entries such as address 404, date of birth 408 etc. can be optionally filled by the user.

In an aspect, after filling all mandatory entries in the registration form, user can provide an input to submit button 418, based on which the filled form information/data can be transmitted to a PEC platform 306 through a long-range network such as Internet. PEC platform, upon receiving such information/data, can route/forward the received information to a specific bank (as described in registration form 400) for verification/authentication. Upon successful authentication/verification by the bank, user can receive a cipher code that can be in any format such as image representation, bank icon, and the like. In an aspect, user can receive a notification/alert (such as email, SMS, MMS) that indicates the user that he is authenticated for executing financial transactions through PEC. In an aspect, PEC platform can store/update all the information to and fro from the user and bank in PEC database (described in FIG. 5).

FIG. 5 illustrates an exemplary PEC platform database for maintaining/storing user and bank communication information in accordance with embodiments of the present disclosure. FIG. 5 illustrates an exemplary PEC database/table 500 that can be utilized to maintain various users account information and registered bank information. For instance, one or more logical tables can be configured at the PEC database 500 to store/maintain details of one or more users along with storing information relating to their debit/credit transactions. As illustrated, the table can include entries such as PEC ID 502, user name 504, bank name 506, cipher information 508, account number 510, and last transaction date 512 among other like information. For an instance, database 500 shows PEC ID 402 is 1AX . . . 32, user name is Adams Hillman, bank registered at PEC platform is JP Morgan Chase, user's bank account number is 1603987654, and last transaction date is Jul. 16, 2016.

Additionally, the database 500 can further include how much each transaction was for, all the previous transactions undertaken by the users along with respective vendor/merchant information.

In an aspect, database 500 fields/entries can be refreshed/updated in real-time for every transaction that is executed. In another aspect, fields/entries can be refreshed/updated in a periodic fashion.

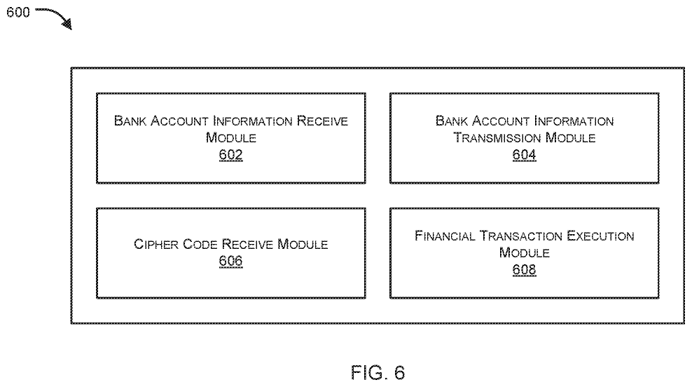

In an embodiment, similar to the databases 400 and 500, bank server can also maintain a database that stores plurality of fields corresponding to each PEC user, such fields can be issued cipher information (described in FIG. 6), bank account number, tax identification number, previous transaction details with timestamp etc.

In an embodiment, it should be clearly appreciated that fields, format, content, attribute, depicted in registration form 400, database 500 and database maintained at bank server are completely exemplary depictions, and any number of suitable fields can be part based on actual implementation of the proposed system.

FIG. 6 illustrates exemplary functional modules that can be implemented at PEC and bank respectively in accordance with an embodiment of the present disclosure.

In an exemplary aspect, FIG. 6 illustrates exemplary modules that can be implemented at the PEC, wherein the proposed system 600 can include a bank account information receive module 602 that can be configured to receive user's bank account information that is specific to a bank, a bank account information transmission module 604 that can be configured to transmit the user's bank account information to the bank through a PEC platform, a cipher code receive module 606 that can be configured to receive a cipher code from the bank based on processing of the user's bank account information at the bank, and a financial transaction execution module 608 that can be configured to enable the user to execute the one or more financial transactions using the cipher code.

According to an aspect, bank account information receive module 602 can be configured to receive bank particulars/details, including but not limited to, bank name, bank account number, IFSC code, branch name, and the like. In an aspect, user particulars can also be received along with bank details, wherein user particulars can include user name, choice of language, location, mobile number, email address, tax identification number, social security number, among others. In another embodiment, user particulars can also include password/passcode/biometric identification that can be stored at the bank and such stored biometrics can be utilized while executing financial transactions. Bank information can be received at registration form interface displayed on the PEC. In an embodiment, a touch screen interface/keypad on a display screen (operatively coupled with the PEC) can be utilized to receive such information.

In an aspect, bank account information transmission module 604 that can be configured to transmit the user's bank account information, through a PEC platform to the bank (as described in registration form 400), wherein bank can be pre-registered at the PEC platform. In an aspect, a transceiver unit configured at PEC can be utilized to transmit the received bank account information to the specific bank through an electronic communication network (such as Internet or Local Area Network (LAN) or Wide Area Network (WAN)). Transmission of user details can be performed through a secure tunnel, virtual private network (VPN), implementation of one or more encryption algorithms.

In an aspect, bank can perform bank account information verification, for an instance, bank can verify whether bank account exists for the user, and if exists, bank can generate a cipher code/information against the account and transmits back to the PEC through PEC platform. Additionally, bank can also register/store received registration information such as biometric identification that can be utilized at the time of financial transaction execution.

In an aspect, cipher code receive module 606 can be configured to receive a cipher code from the bank based on processing of the user's bank account information at the bank such that the cipher code is unique to the user's bank account information. In an embodiment, transceiver incorporated in the PEC can be utilized to receive cipher code/encrypted information and/or an icon/graphics file or any other suitable notation, wherein upon receiving such information, an icon that represents the specific bank can be displayed on the PEC display screen. Generated icon can be utilized for performing financial transaction, wherein such icon can be used to uniquely recognize the user (similar to user's bank account number),In an embodiment, cipher code/information can be in any format, for an instance, if bank is JP Morgan Chase, JPMC0s123 can be cipher information, wherein JPMC can indicate JP Morgan Chase bank. In another example, if bank is American Express Bank, x98AEB can be cipher information, wherein AEB can indicate American Express Bank. In an aspect, cipher information can include user specified information and/or bank generated information and/or PEC platform generated information.

In an aspect, financial transaction execution module 608 can be configured to enable the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC. For an instance, upon swiping PEC in a slot of POS, information including transaction amount (say 9 dollars), biometric identification, and the cipher code can be transmitted from the POS to a merchant bank, wherein upon receiving such information, merchant bank can communicate with the specific bank associated with PEC for verification. Once PEC bank verifies, PEC bank can communicate back with the merchant bank to communicate verification information. Merchant bank can further communicate authorization information to the POS to complete the financial transaction.

In an aspect, multiple icons of different banks to which user transmits registration request and in response receives cipher information, icons of all such banks can be generated at the PEC.

In an aspect, bank account information request can be received (in real time) at the specific bank (through the PEC platform) as described in the registration form. In an aspect, received bank account information can be authenticated by matching the received information with the user information pre-stored at the bank, and if received information matches with the pre-stored information, user can be successfully authenticated/verified. For an instance, user name, bank account number, etc. can be received as registration information and same can be matched with the pre-stored user name, bank account number, etc, upon successful match user can be authenticated.

In an aspect, bank can generate a cipher code/information against the successful verification of the received registration information. Such cipher code can be generated by utilizing any or combination of encryption mechanisms such as DES, RSA, MD5, HASH, AES, HMAC, SHA-1.

In an aspect, the generated cipher information can be transmitted from the bank to the PEC through PEC platform. In an aspect, generated cipher code can be transmitted to the PEC platform that can store/update the PEC database 500 and forwards/routes the cipher code to the respective PEC for financial transactions execution.

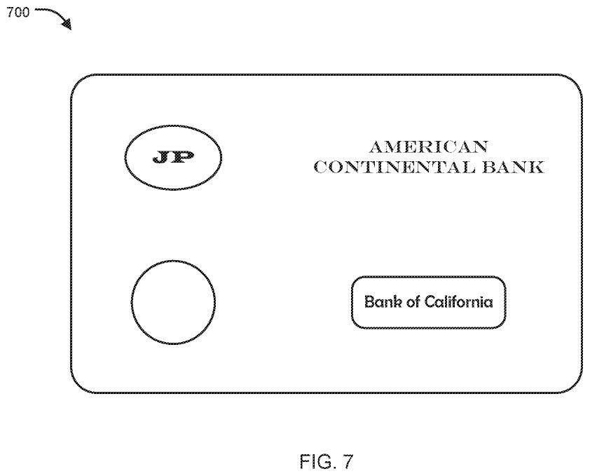

FIG. 7 illustrates an exemplary PEC interface including multiple banks for executing financial transactions in accordance with embodiments of the present disclosure. FIG. 7 illustrates an exemplary PEC 700 that include icons of plurality of configured banks such as JP Morgan Chase, American Express Bank, American Continental Bank, Bank of California etc. User can tap an icon of a bank displayed on a PEC display interface to select an appropriate bank for executing financial transaction. Financial transactions may include fund transfer, ATM withdrawal, online shopping, shopping through POS etc.

In an embodiment, illustrated banks on the PEC display interface are only exemplary and any number of banks can be configured. In a similar fashion, if user wishes to discontinue services of a bank, unsubscribe request for a particular bank can be transmitted from the PEC to the PEC platform that can notify respective bank for such request. Bank can execute various actions such as disabling stored cipher information corresponding to the user or account deletion etc. to unsubscribe the user.

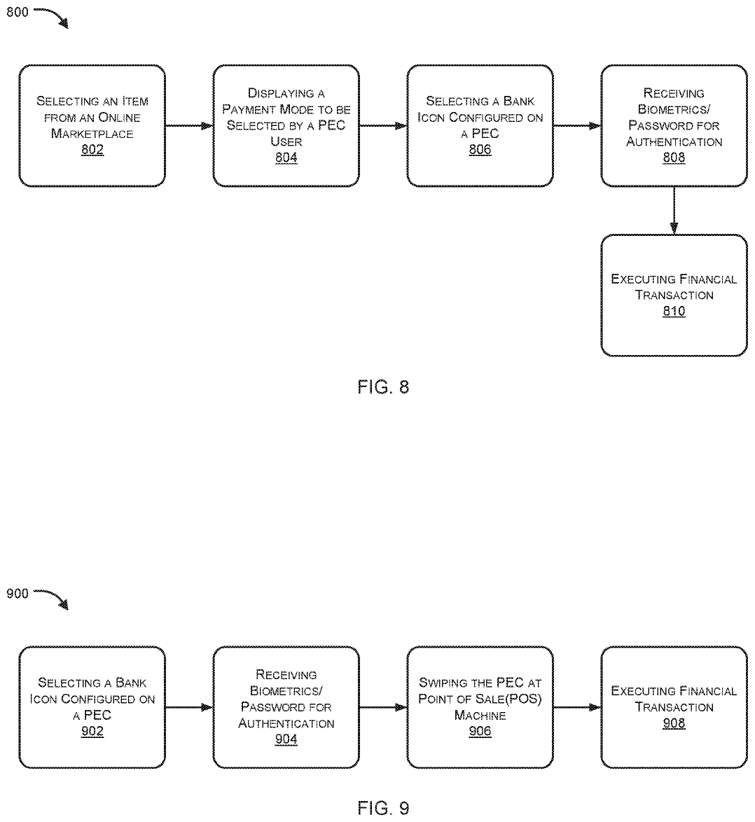

FIG. 8 illustrates an exemplary block diagram illustrating shopping from online marketplace by utilizing PEC in accordance with embodiments of the present disclosure.

Block 802 illustrates selection of an item for shopping from an online marketplace such as amazon.com. In an aspect, user can utilize a PEC device to access (through a mobile application or a website or by any suitable mechanism) the online marketplace and select one or more items that user wishes to shop for. In an aspect, website of the online marketplace can be displayed on a PEC display screen, wherein such display can be enabled according to the form factor of PEC display. User can tap/select display done or more items through touch interface of the PEC.

Block 804 illustrates that upon selection of the item, payment mode can be displayed on the PEC, and upon making appropriate financial transaction/payment through the PEC, item can be purchased. In an aspect, payment mode can be online fund transfer, wherein online fund transfer can be selected to utilize the PEC for executing financial transaction.

Block 806 illustrates an exemplary scenario where the PEC user can select a bank of his choice (in case multiple banks are displayed on PEC display screen) by tapping on an icon of a particular bank. In an aspect, icons of multiple banks can be arranged on the display in alphabetic order or based on frequency of usage of specific bank or can be set by default in a particular order.

Block 808 illustrates upon receiving of such tapping on the bank icon, an interface can be displayed to receive desired price of the selected item and user authentication corresponding to the tapped bank icon. Such user authentication input can be a password/PIN/biometric identification (fingerprints, hand geometry, earlobe geometry, retina and iris patterns, voice waves, DNA) that can be provided by the user, wherein such authentication input can be transmitted to the respective bank (that already stores user authentication signature as received at the time of registration) for verifying authentication signature.

Block 810 illustrates execution of financial transaction by transferring entered item price of the selected item, authentication signature and cipher information (corresponding to the bank) to the respective bank, wherein upon receiving such information, bank can match the received authentication signature with the pre-stored authentication signature for verification. Once user is verified, user bank can communicate with the bank associated with the online marketplace to complete the financial transaction.

In an embodiment, one or more notifications/alerts can be transmitted to the PEC in any form for instance, SMS, email to indicate the user that a transaction is occurred in the user account and all information that relates to the transaction such as bank account number, bank account holder name, address etc. can be included in the notification message, vendor name, vendor address.

In another embodiment, user authentication can be performed first and after successful authentication, item price and cipher information can be transmitted to execute financial transaction.

In an aspect, a user can browse online marketplace on a computing device (such as a tablet, smart phone, personal digital assistant (PDA), a tablet, a microchip etc.) and can execute a financial transaction through the computing device by providing appropriate PEC credentials. In another aspect, user can shop an item and make appropriate financial execution upon receiving home delivery of the item. Such financial transaction can be performed by establishing near field communication (NFC) between the PEC and the other device that can receive payment from the PEC.

FIG. 9 illustrates an exemplary block diagram illustrating shopping through POS by utilizing PEC in accordance with embodiments of the present disclosure.

Block 902 selection of a bank by a user can be performed in a similar way as described in Block 806.

Block 904 illustrates exemplary biometric authentication as disclosed in Block 808.

Block 906 illustrates swiping of a PEC in a swiping slot of a POS machine, wherein a merchant of POS can enter shopping amount and provides input on the POS machine to connect with a merchant bank (that can be registered on a PEC platform).

Block 908 illustrates execution of financial transaction based on receiving of shopping amount and a cipher information (that relates to PEC) at a merchant bank. Merchant bank can communicate with the bank that was initially opted by PEC user. User selected bank can authorize the transaction and sends the authorization information to the merchant bank, wherein merchant bank upon receiving authorization information, communicates with the POS to complete the financial transaction.

Although the aspects disclose entering of biometric information before the swiping, however any mechanisms that can enable receiving of biometric indications after swiping are also within the spirit of the present disclosure.

In an aspect, a first application that enables the PEC to execute financial transaction and/or a second application that enables the PEC platform to execute financial transaction can be configured on a computing device such as a tablet, smart phone, personal digital assistant (PDA), a tablet, wearable device, a microchip etc., wherein the first application and/or second application can be mobile application, web application, and the like. For an instance, a user can withdraw money/amount/currency from an ATM kiosk by using the first application configured on the smart watch and the second application configured on tablet. In an exemplary implementation, user can input information/details (bank selection, user credentials, amount to be withdrawn, a preferred location etc.) on a user interface of the first application displayed on the smart watch, wherein smart watch can transmit the details to the selected bank through the second application (corresponding to the PEC platform). Upon receiving such information, bank can verify user credentials and the availability of amount in the user bank account, in case credentials are verified and requested amount is available in the user bank account, bank can transmit a geographical map (to the smart watch) indicating at least one ATM kiosk around the preferred location. Once user selects a particular ATM kiosk from the displayed ATM kiosks, such selection can be communicated to the selected ATM kiosk based on which selected ATM kiosk and/or bank can transmit a secret code to the smart watch, wherein secret code can be entered by the user on the first application interface. As soon as the secret code is transmitted from the smart watch to the ATM kiosk, ATM kiosk can dispense the desired amount.

In an aspect, secret code can be expired after a predetermined time interval. In an aspect, according to the preferred location if most suitable bank is not having the desired amount/not operational, other nearby ATM kiosk can be suggested on the smart watch.

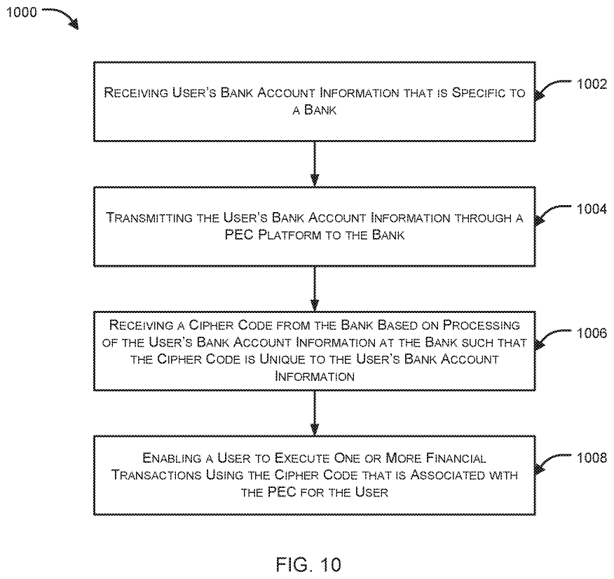

FIG. 10 illustrates an exemplary flow diagram showing steps involved in setting up a PEC for execution of financial transactions by a user of a PEC in accordance with embodiments of the present disclosure. In an aspect, the proposed method can include the steps of, at step 1002, receiving user's bank account information that is specific to a bank, and at step 1004, transmitting the user's bank account information, through a PEC platform, to the bank. Method 1000 can further include, at step 1006, receiving a cipher code from the bank based on processing of the user's bank account information at the bank such that the cipher code is unique to the user's bank account information, and at step 1008, enabling the user to execute the one or more financial transactions using the cipher code that is associated with the PEC for the user.

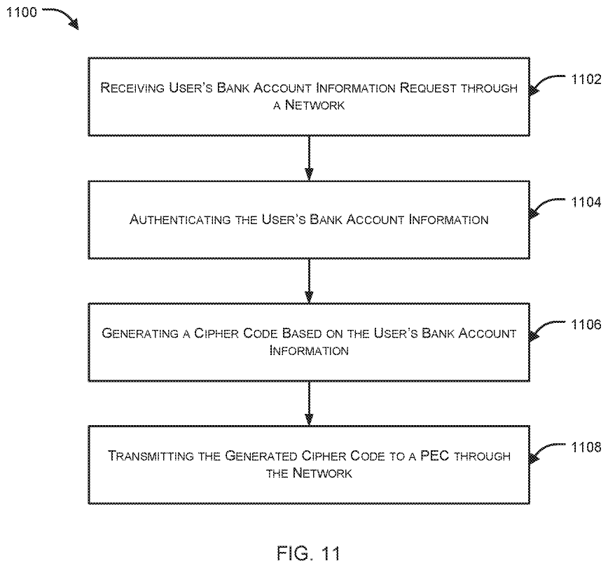

FIG. 11 illustrates an exemplary flow diagram showing steps involved in issuance a cipher code for financial transaction execution, in accordance with embodiments of the present disclosure. In an aspect, the proposed method can include the steps of, at step 1102, receiving user's bank account information request through a network, and at step 1104, authenticating the user's bank account information. Method 1100 can further include, at step 1106, generating a cipher code based on the user's bank account information, and at step 1108, transmitting the generated cipher code to a PEC through the network.

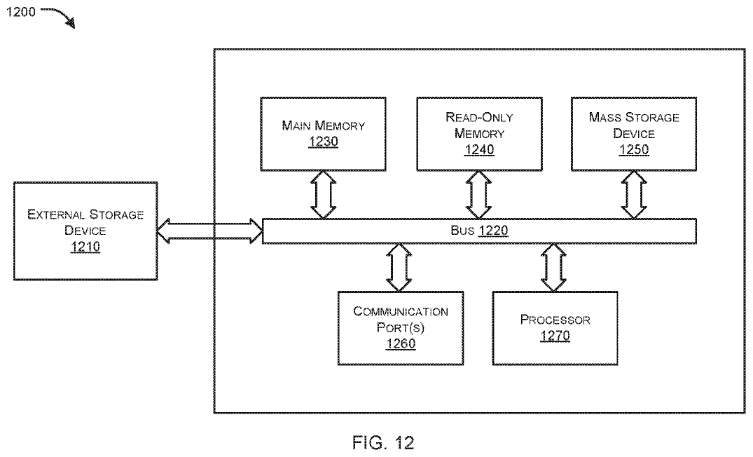

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown in the FIG. 12, computer system 1200 includes an external storage device 1210, a bus 1220, a main memory 1230, a read only memory 1240, a mass storage device 1250, communication port 1260, and a processor 1270. A person skilled in the art will appreciate that computer system 1200 may include more than one processor and communication ports. Examples of processor 1270 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 1270 may include various modules associated with embodiments of the present invention. Communication port 1260 can be any of an RS-232 port for use with a modem based dialup connection, a 10/100 Ethernet port, a Gigabit or 10 Gigabit port using copper or fiber, a serial port, a parallel port, or other existing or future ports. Communication port 1260 may be chosen depending on a network, such a Local Area Network (LAN), Wide Area Network (WAN), or any network to which computer system 1200 connects. Memory 1230 can be Random Access Memory (RAM), or any other dynamic storage device commonly known in the art. Read only memory 1240 can be any static storage device(s) e.g., but not limited to, a Programmable Read Only Memory (PROM) chips for storing static information e.g., start-up or BIOS instructions for processor 1270. Mass storage 1250 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus 1020 communicatively couples processor(s) 1270 with the other memory, storage and communication blocks. Bus 920 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1270 to software system. Optionally, operator and administrative interfaces, e.g. a display, keyboard, and a cursor control device, may also be coupled to bus 1220 to support direct operator interaction with computer system 1200. Other operator and administrative interfaces can be provided through network connections connected through communication port 1260. External storage device 1210 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “determining”, “adjusting”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present invention also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should therefore be determined with reference to the appended claims, along with the full scope of equivalents to which such claims are entitled.

### ADVANTAGES OF THE INVENTION

The present disclosure overcomes one or more disadvantages associated with conventional financial transaction execution systems.

The present disclosure uses a single card for all the transactions of different banks.

The present disclosure makes more secure payments by enabling cipher text and biometrics.

The present disclosure utilizes a single card for any financial service in which payment is required.

The present disclosure provides a thin card that can be carried in a user wallet.

The present disclosure is to enable banks, users, merchants, Government authorities etc. to collaborate through common PEC platform and enable execution of financial transactions.

I claim:

1. A personal electronic card (PEC) for execution of financial transactions by a user of the PEC comprising:
a transceiver means, a display means, a non-transitory storage device having embodied therein one or more routines operable to facilitate execution of one or more financial transactions by the user; and
one or more processors coupled to the non-transitory storage device and operable to execute the one or more routines, wherein the one or more routines include:
a bank account information receive module, which when executed by the one or more processors, receives the user's bank account information that is specific to a bank;
a bank account information transmission module, which when executed by the one or more processors, transmits, through a PEC platform, the user's bank account information to the bank;
a cipher code receive module, which when executed by the one or more processors, receives a cipher code from the bank based on processing of the user's bank account information at the bank such that the cipher code is unique to the user's bank account information;
a financial transaction execution module, which when executed by the one or more processors, enables the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

2. The system of claim 1, wherein the common PEC platform is configured at a server or at a cloud.

3. The system of claim 1, wherein the user is enabled to add one or more bank accounts to the PEC, wherein each bank account has a corresponding cipher code that is associated with the PEC.

4. The system of claim 1, wherein the cipher code is associated with a bank icon that is displayed on a display screen of the PEC, and wherein selection of the bank icon is used to initiate at least one financial transaction with a third-party through the bank.

5. The system of claim 1, wherein the one or more financial transactions are executed using biometric authentication of the user on the PEC.

6. The system of claim 1, wherein the user's bank account information comprises any or a combination of user's bank account number, user's name, bank branch name, bank name, and bank IFSC code.

7. A method for execution of financial transactions by a user of a PEC, said method comprising the steps of:
receiving user's bank account information that is specific to a bank;
transmitting the user's bank account information, through a PEC platform, to the bank;
receiving a cipher code from the bank based on processing of the user's bank account information at the bank such that the cipher code is unique to the user's bank account information;
enabling the user to execute the one or more financial transactions using the cipher code that is associated with the PEC for the user, wherein the one or more financial transactions are executed either using a magnetic strip and/or a sensor that is configured in the PEC, or through the display means that enables the user to initiate the one or more financial transactions and get the user authenticated using the cipher code that is associated with the PEC.

8. The method of claim 7, wherein the common PEC platform is configured at a server or at a cloud.

9. The method of claim 7, wherein the user is enabled to add one or more bank accounts to the PEC, wherein each bank account has a corresponding cipher code that is associated with the PEC.

10. The method of claim 7, wherein the cipher code is associated with a bank icon that is displayed on a display screen of the PEC, and wherein selection of the bank icon is used to initiate at least one financial transaction with a third-party through the bank.

11. The method of claim 7, wherein the one or more financial transactions are executed using biometric authentication of the user on the PEC.

12. The method of claim 7, wherein the user's bank account information comprises any or a combination of user's bank account number, user's name, bank branch name, bank name, and bank IFSC code.
